(19) United States
(12) Patent Application Publication
(10) Pub. No.: US 2013/0204699 A1
(43) Pub. Date: Aug. 8, 2013

(54) Method and Apparatus for Targeted Advertisement Delivery

(71) Applicants: Perry Robinson MacNeille, Lathrup Village, MI (US); Yimin Liu, Ann Arbor, MI (US); Oleg Yurievitch Gusikhin, West Bloomfield, MI (US); Mark Schunder, South Lyon, MI (US)

(72) Inventors: Perry Robinson MacNeille, Lathrup Village, MI (US); Yimin Liu, Ann Arbor, MI (US); Oleg Yurievitch Gusikhin, West Bloomfield, MI (US); Mark Schunder, South Lyon, MI (US)

(73) Assignee: FORD GLOBAL TECHNOLOGIES, LLC, Dearborn, MI (US)

(21) Appl. No.: 13/366,426

(22) Filed: Feb. 6, 2012

(51) Int. Cl. G06Q 30/02

(52) U.S. Cl. 705/14.53

(57) ABSTRACT

A computer implemented method includes retrieving one or more data elements relating to user shopping habits. The method also includes identifying one or more merchants along a route corresponding to the one or more data elements. The method further includes identifying at least one advertisement for at least one of the one or more merchants. Also, the method includes presenting the advertisement to a vehicle occupant, as a vehicle moves within a perimeter of a merchant for which an advertisement has been identified.

### TECHNICAL FIELD

The illustrative embodiments generally relates to methods and apparatuses for targeted advertisement delivery.

### BACKGROUND

Billions of dollars a year are spent on marketing, advertising, consumer surveys, coupon mailings, and countless other forms of product placement, all with the goal of reaching consumers who wish to then purchase the subject products. Of course, a vast amount of this material falls on deaf ears. Adults without children are probably not interested in baby food. Non-drinkers don't care about beer advertisements. This wastes both the advertiser's money and vehicle occupant's time. It may even detract from the driving experience and cause distress.

Even if the product in question might normally appeal to someone, there is a great deal to be said for timing. An advertisement at 7 AM for ice cream, when the user is not within 30 miles of the ice cream serving location, is almost certainly not going to (at least at that time) encourage the user to change directions and head to the nearest ice cream store.

Advertising over the internet has attempted to adjust, somewhat, to targeting consumers. Information about browsing and purchasing habits, stored on a user's PC as data, can help inform potential advertisers as to the relative interest a particular user might have. This, of course, is simply a more refined version of the old forms of targeted advertising (e.g., running beer and potato chip advertisements during the Super Bowl). Both make assumptions about a user at some level, and provide advertisements based on an educated guess.

### SUMMARY

In a first illustrative embodiment, a computer implemented method includes retrieving one or more data elements relating to user shopping habits. The method also includes identifying one or more merchants along a route corresponding to the one or more data elements. The method further includes identifying at least one advertisement for at least one of the one or more merchants. Also, the method includes presenting the advertisement to a vehicle occupant, as a vehicle moves within a perimeter of a merchant for which an advertisement has been identified.

In a second illustrative embodiment, a machine readable storage medium stores instructions that, when executed by a processor, cause the processor to perform a method including retrieving one or more data elements relating to user shopping habits. The illustrative method also includes identifying one or more merchants along a route corresponding to the one or more data elements. Further, the method includes identifying at least one advertisement for at least one of the one or more merchants. The method also includes presenting the advertisement to a vehicle occupant, as a vehicle moves within a perimeter of a merchant for which an advertisement has been identified.

In a third illustrative embodiment, a computer implemented method includes tracking user progress along a route to determine one or more intermittent stopping location, where the user stops with the intention of making a purchase. In this illustrative method, for each intermittent stopping location, the process includes recording data including at least time of day, distance from the route, and duration of time spent at the stopping location. Also, the method includes aggregating recorded data to compile a user profile defining shopping habits of a user when detouring from a route.

### BRIEF DESCRIPTION OF THE DRAWINGS

FIG. 1 shows an illustrative example of a vehicle computing system;

FIG. 2 shows an illustrative example of an advertisement provision process;

FIG. 3 shows an illustrative example of a preference tracking process;

FIG. 4A shows another advertisement provision process;

FIG. 4B shows still another example of an advertisement provision process;

FIG. 5 shows an example of an advertisement weighting process;

FIG. 6 shows an illustrative example of an advertisement provision system; and

FIG. 7 shows an illustrative example of a route analysis result.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

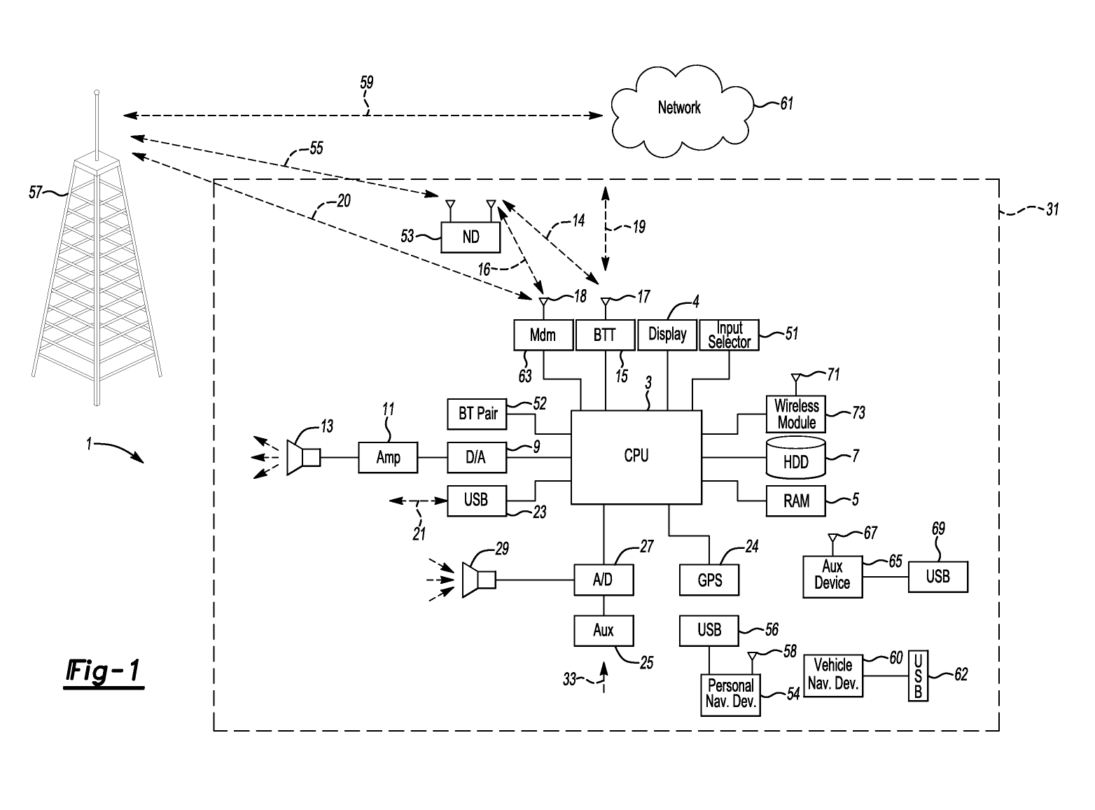

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connections. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Modern location based advertising is designed for delivery to desktop PCs, radio, TVs, and other stationary devices. Typically, the advertising doesn't incorporate spatial filtering, because of, for example, the non-transitory location of the devices. While it may be useful to know, for example, a zip code of a device to which advertising is delivered; little other than that piece of information can be used to target ads to a user. A TV, PC, radio, etc., doesn't typically know, for example, the travel habits of a user; purchasing preferences while traveling, stop times, detour willingness, etc. While it may be useful to deliver a targeted advertisement, even to a stationary device, if this data was known, a television, for example, has little to no means of actually gathering this information.

Vehicle advertisements also can be set up for future delivery, for example, if a route is known. By monitoring a route, advertisement planning can be modified and delivery can be targeted to be spot on based on both a user's preferences and current location. On a long trip, for example, refueling times of day can be known (based, for example, on previously observed behavior and, for example, remaining fuel calculations). Similarly, time for eating can be known based on observed behavior, as well as type of preferred eating for various meals and even specific restaurant preferences. In one example, this can be done using a learning algorithm that anticipates the user's reactions based on prior observations of behavior. The algorithm works by making a suggestion and observing the user's reaction. It may include a forgetting function so that old observations are eventually retested.

On local trips, advertisements related to local businesses, within, for example, a fixed perimeter from or reasonably proximate to a local route. Different business may have different perimeters associated therewith. For example, a user may be willing, based, for example, on observed or input behavior, to travel four miles off route to obtain food, but may only be willing to detour half a mile or less to purchase gasoline or groceries. User input and observed behavior can help determine the particulars in these situations. Additionally, advertisements can be filleted such that trips to the merchants to not add too much time or energy consumption cost to a particular journey.

An automotive spatial filtering device is proposed to support a consumer's long trip and daily commute to filter advertisements and provide them to a consumer. The filter is useful because of the extraordinary growth in the number of advertisements and the ability gather massive amounts of data using cloud based resources. Utilizing spoken dialogue and user behavior observance, it is possible to learn users' seemingly obscure preferences with syntactic analysis and informational filters.

The filter is able to determine “local” businesses along any sort of route, be it a daily commute or a long haul journey. Long haul trips, for example, may be a route from an origin to a distant destination, which may require one or more meal stops, refueling stops, shopping stops, etc. The filter may also be able to process geographic information that may be of significance. Some people for example, may prefer to do business or stay in locations proximate to golf courses, fishing spots, prefer scenic views, etc. GIS databases, such as, but not limited to, the US Geographical Atlas can provide thousands of geographic entities that can be factored into consideration.

The perimeter around a local commute, for example, can be defined by observed historical information on user behavior that can serve to show what the user considers to be “in range.” Maximum route deviances, typical route deviances, frequency of deviances, etc. can all be used to define perimeters. The deviances can also be more or less time of day specific, and/or can relate to the type of a stop being made. Penalty functions/weightings to businesses not fitting a typical deviance model can be applied to filter advertisements to those most likely acceptable by a user.

Spatial filtering can also assign a cost/penalty based on the cost of travel to a location. This can include, but is not limited to, travel costs, travel time, distances, and a travel environment. A preferable location which is only reachable by a undesirable route may be less desirable than slightly less desirable location reachable by a far more desirable route.

Time can also be considered, including time of day. For example, in a long haul journey there could be places a vehicle may stop for lunch, shopping, refueling and sleeping. Hotel advertisements could be filtered based on a predicted stopping/sleeping time, eating advertisements could be based on a predicted eating time. Refueling locations can be based on a vehicle's distance to empty calculation and/or, for example, a driver's tendency to allow fuel to drop below a certain level.

The filter could also be dynamic. It can update during a trip based on a current location and estimated travel speed of the vehicle. Of course, to be most effective, some potentially personal data may need to be used to provide filtering. In at least one example, the process can store personal data on a user's personal computer and access the data from there. Strong private encryption can be used in data transfers, and any data transferred to a cloud based site for processing can be scrubbed of any personal information relating the data to a user identity.

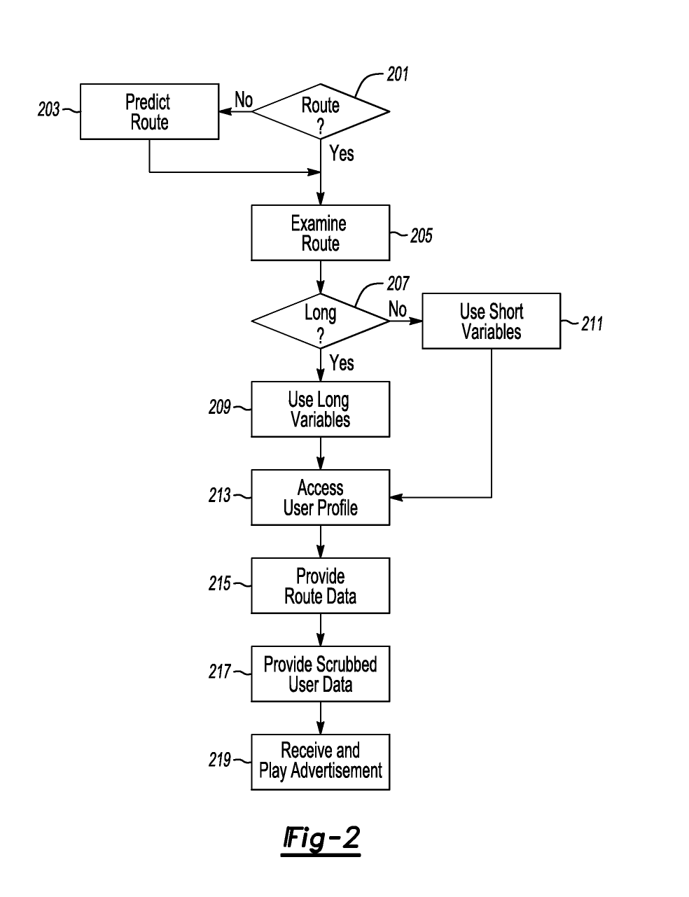

FIG. 2 shows an illustrative example of an advertisement provision process. In this illustrative example the process first determines if a route is known or has been input 201. The route could be obtained, for example, from a vehicle navigation system, a phone in communication with a vehicle computing system, a portable navigation device, etc. If a route is not known, known techniques can be used to predict a route 203. These prediction techniques can be based on, for example, observed behavior and are not the focus of this application, but can be applied to facilitate the techniques disclosed herein.

Once a route is known or obtained, the route can be examined by the process 205. One consideration of the process could be whether the route qualifies as a “long” or “local” route 207. Since different considerations may be used by filters based on the type of route, it may be useful to know whether the route is a commonly traveled route (which may also have specific arrival time requirements, such as, for example, a job start time) or a vacation/business travel route which may only require a traveler to arrive at a destination at an approximate time.

Based on the type of route (determinable, for example, by distance, time, etc.) the process may decide to utilize variables relating to long routes 209 or local route 211. There may be some overlap in variables, and there may be independent variables related to each of the types of routes. A user profile may also be accessed 213, to fill in values for usable variables, determine applicability of certain variables, obtain user preferences, etc.

In this particular instance, the exemplary process is running on a local vehicle computing system or local system (e.g., a smart phone) in communication with the vehicle computing system. Since cloud based computing can provide potentially faster and more expansive processing and information access capability, the process provides the route data 215 and user data 217 to a cloud based processing system. The user data, before provision, in this example, is scrubbed of personal information, so that only generic preference data, not linked to user identity, is provided to the remote system. The local process then receives a list of advertisements for delivery 219, or it can receive advertisements as appropriate based on points in the journey.

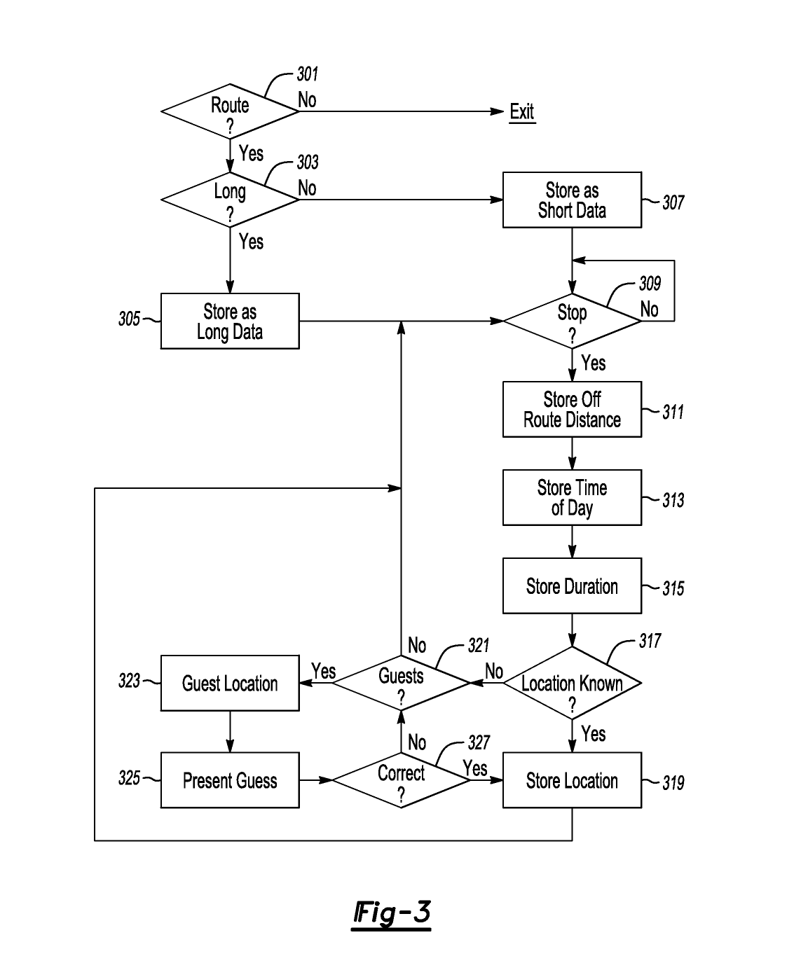

FIG. 3 shows an illustrative example of a preference tracking process. In this example, the process again determines if a route is known. This example deals with tracking user preferences, and if a route is unknown a route can be predicted (not shown), or the process can exit if a route is unknown and/or unpredictable. This process can also largely or exclusively run in the background whenever a journey is made, so a user does not need to be bothered by the data gathering process. In certain instances, for example, to confirm a destination, purchase, commonality of purchase, etc., the process may briefly interact with a user if desired.

Once there is a route hypothesis, the process determines if the route is a “long” route or a local one. If the route is local, the data is stored with respect to local routes 307, if the route is long, the data can be stored with respect to long routes 305. In the case of known or previously recognized locations, the process can even store data specifically with respect to the exact route/destination.

Regardless of the number/types of journeys being tracked, the process can then determine if a stop is made at any point 309. Once a stop is made (detectable by know techniques, such as, for example, park state, vehicle exits, etc.), the process can store a distance of the stop from known routes 311. This can aid in a determination as to how far the driver is willing to travel off of a route to attend to any business, or to attend to a specific type of business (e.g., without limitation, lunch, fuel, shopping, etc.).

In addition to storing an off route distance, the process can also store a time of day 313. This information can be used to determine eating times, refueling times, shopping times, etc. It can also be used to determine commonality of deviances at particular time, and willingness to deviate from a route at particular times. In addition, the process can store the duration of a stop 315. This can be used to determine how long a user will stop for types of shopping, at certain times of day, etc.

The process may also check to see if a location is known 317. For example, based on GPS coordinates, an address may be available, and the address may be correlatable to a known business. The name/type of location can be used in filtering to determine the preferences of a user for shopping, stopping, etc. It can also be cross referenced with a distance off route/stop time to determine how long/far a user will travel for certain goods/services. If the location is known (e.g., a single business at an address where the vehicle is stopped), the location data (business name, business type, goods sold, etc.) can be stored 319. If the location is unknown (multiple businesses, car in parking lot, mall, etc.) the process can attempt to guess at a business 321.

If a guess is made, the process can guess a location or multiple options and provide a user with a list of possible stops for confirmation 325. If any guess is correct 327, as, for example, confirmed by a user, the process can store the appropriate information 319, if a guess cannot be made or, for example, user interaction is not desired, the process can then continue tracking user behavior.

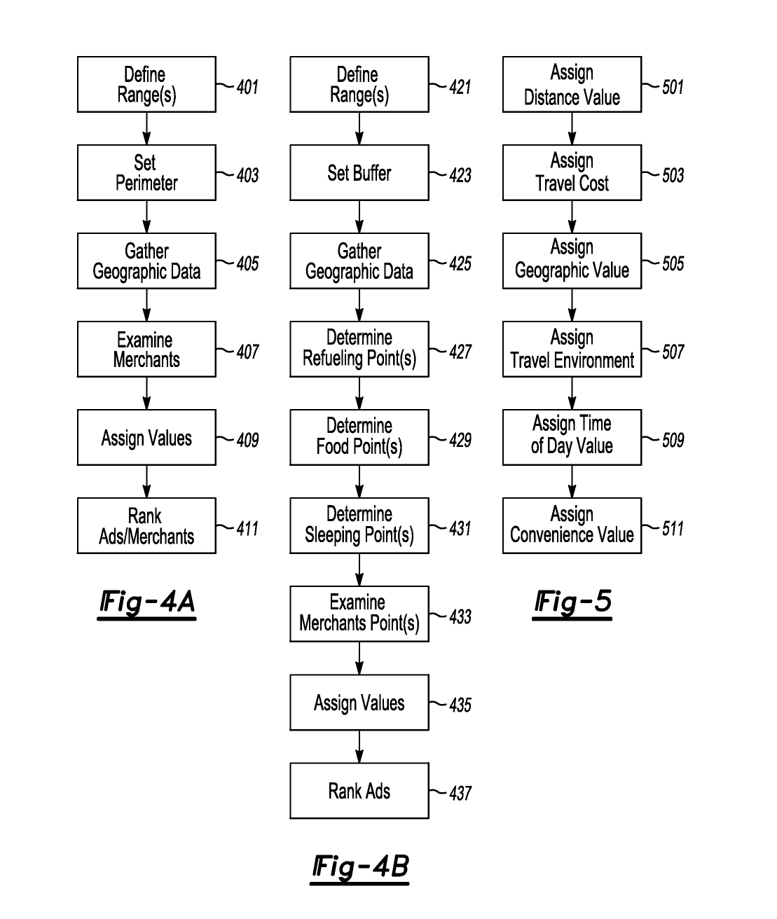

FIG. 4A shows another advertisement provision process. In this illustrative example, a “local” advertisement provision process is shown. One or more ranges of deviance is determined 401. In one example, a fixed deviance for all possible stops is determined 403, by, for example, reference to individual driver behavior. In another example, the process determines deviances based on a variety of factors, including, but not limited to, type of business, time of day, reason for stop, etc.

One or more perimeters are then established for the given route 405. In this example, it is businesses within this/these perimeter(s) that will be examined for advertisements. Suitable merchants can be determined 407 and corresponding values can be assigned to the advertisements of these merchants 409. These values can include variances based on type of good, preference for goods/services, distance from route, route of travel to merchant, time of stop, etc.

Once the advertisements have been weighted, according to, for example, known user preferences, the process can then rank the advertisements for delivery to vehicle occupants 411. A bundle of advertisements with related time/location delivery instructions can be sent to a vehicle, or the advertisements can be queued remotely and/or adjusted if needed based on changes in travel/route/time/etc.

FIG. 4B shows still another example of an advertisement provision process. In this example the process relates to a longer journey from the process shown in FIG. 4A. Again, the process may define one or more ranges of deviance 421. Based on desired deviance(s), the process can set one or more buffers/perimeters along a route. These can be based on, but are not limited to, ranges of stops for shopping, sleeping, refueling, eating, etc.

Additionally, geographic data may be taken into account, gathered from, for example, an online GIS 423. When making a daily commute, it may not matter as much if a person stops for five minutes from a particularly disfavored geographic site, but on a longer trip, the person may prefer stops for, for example, food or rest, in a location satisfying certain preferences. These preferences can be observed or user-input. It is even possible to classify a party based on observed preferences and guess at what other preferences the user may have based on known preferences.

Since the trip may require one or more stops for food, shopping, sleeping, refueling, etc., the process may determine a number of points for eating 429, sleeping 431, shopping 433, etc. Some of the points may be somewhat dynamic, for example, a sleeping point. If the journey began at 3 PM, sleeping points can be determined from 10 PM up until 3 AM, since it may not be known when a user will wish to stop. In at least one embodiment, a user can be asked about a particular distance or time achievement along a route before a stop is desired, and sleeping points (or other suitable locations) can be determined accordingly.

Each point, with a corresponding buffer/perimeter, can then have values applied to merchants within the perimeter. For example, without limitation, a food stop can set a perimeter which a user is willing to travel for food, and then can examine all restaurants within the perimeter. Preferred food types and or restaurants can be noted, and the list can be cross referenced for available advertisements for these locations. Each advertisement can then have values related to user preferences assigned thereto 435, so that an order of likely preference can be determined. Advertisements may then be ranked according to known preferences and user likelihood of response 437, so that the most likely to be used advertisements can be delivered to a user. The advertisements can be delivered as the user approaches the location, or at any point along the journey suitable for delivery.

For example, it may be the case that a typical user eats dinner around six PM. The process can determine where a user is likely to be located at six PM, and can examine surrounding areas for suitable eateries. Advertisement delivery could begin, for example, at four PM, designed to remind a user that a food stop may be desirable. The frequency of advertisements of a particular type could increase around six PM, and could “target in” on a known stopping location with sufficient choices to satisfy a user. Advertisements could also be “linked” to a route, so that, for example, if a user desires a particular stop, the user could select an advertisement and have a point of interest added to an existing route. Selection of a location could even result in electronic coupon delivery for use at the location.

FIG. 5 shows an example of an advertisement weighting process. This example shows some elements that may be considered in the weighting of a certain stop/business for advertisement delivery/user consideration. In this illustrative example, the process first assigns one or more values to each business based on a distance from, for example, a known route 501. The values assigned could vary based on, for example, certain business types, times of day, and other known patterns of the user behavior.

The process can also assign, for example, a travel cost 503. The travel cost can relate to, for example, a fuel/energy cost, a time cost, etc. As with the distance costs, these costs can be tempered based on time of day, type of service, etc. In at least one instance, the process may also have access to a shopping list for a user, and the cost can be tempered based on the necessity (as provided by a user) to the good(s) being obtained.

Geographic values are also assigned in this example 505. These correspond, for example, to items of interest from a GIS database. A user may have a preference for sleeping in certain locales or environments, avoiding certain areas, avoiding certain routes of travel, etc. In addition to assigning a GIS location value to a location, the process could also assign values to a location based on a route required to travel to the location. In this example, this secondary consideration could also be covered by the assignment of a travel value 507, which could include, but is not limited to, types of route, quality/type of road, known crime statistics (high vehicle theft, for example), proximity to certain features, scenic value of a route, etc.

Also, in this example, time of day values can be assigned 509. The process can include, for example, assignment based on how long a user is willing to stop for a meal, a snack, gas, etc., and whether this time value changes based on a time of day. For example, a user may take no longer than ten minutes for breakfast, but the user may be willing to stop for a longer period of time for lunch or dinner. This can be known based on input data or observed user behavior.

Convenience values can also be assigned 511, based on, for example, the number of goals that can be accomplished based on the stop. One stop of questionable preference may provide a number of food, refueling and shopping options, and may, resultantly, be preferable to a stop providing only a singular option, which may in and of itself be more preferable. Any suitable number of weighting/penalty factors may be considered, and this example merely provides a few instances of options for weighting particular points of interest.

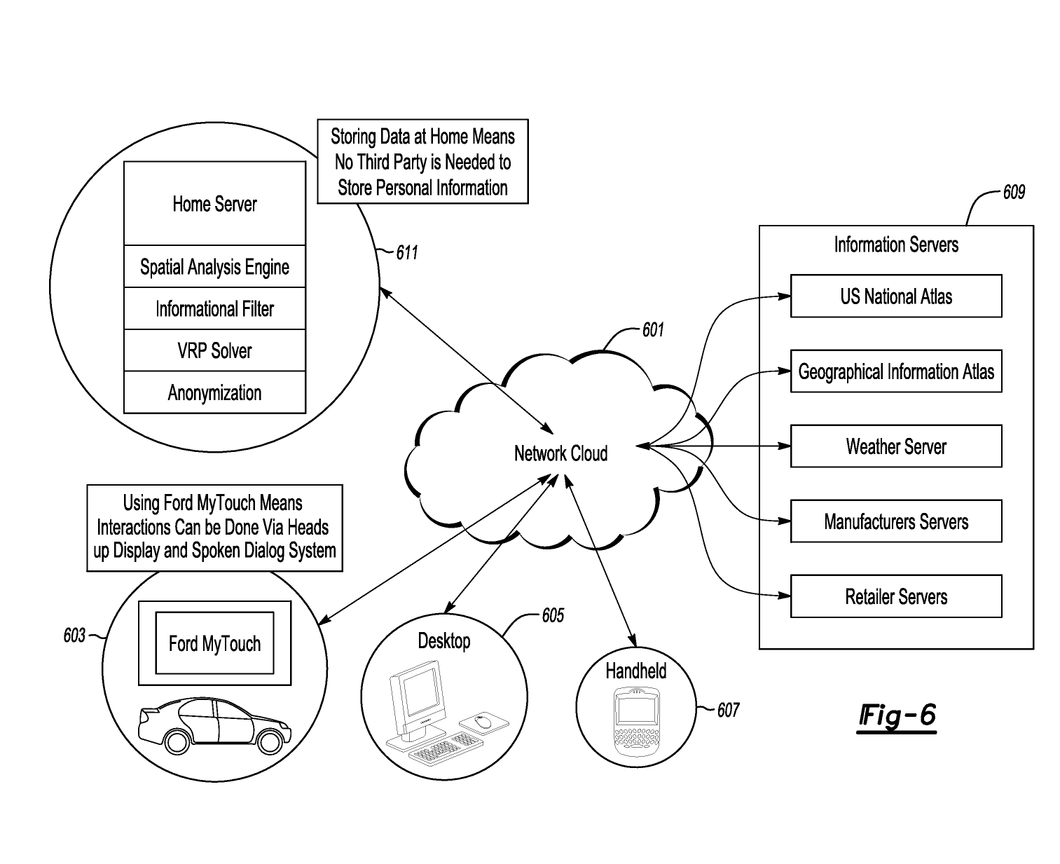

FIG. 6 shows an illustrative example of an advertisement provision system. This is just one illustrative example of a provision system, and, in this case, user data that may be personal can be stored (and even processed, in some cases) on a user's home PC (or other private PC). In this case, the cloud 601 (e.g., for example, the internet) is used to provide a central source for data gathering/transferring.

One resource, usable, for example, for data delivery is a vehicle computing system 603. The process can also be used for data gathering, depending on what type of data is needed. Gathered data or other desirable data can be transferred through the cloud. Desktops 605, handheld devices 607, and other devices can be used for this sort of information delivery and gathering.

Many resources 609 are also available through the Internet. These resources include, but are not limited to, Atlas services, GIS atlases, weather servers, traffic servers, advertisement servers, manufacturer servers, retail servers, etc.

A user PC (or other suitable medium) can be used to store user data 611. The system can be used, if capable and/or desired, to process information, anonymize information, etc. Or it can be used as a mere database, if secure processing is available elsewhere.

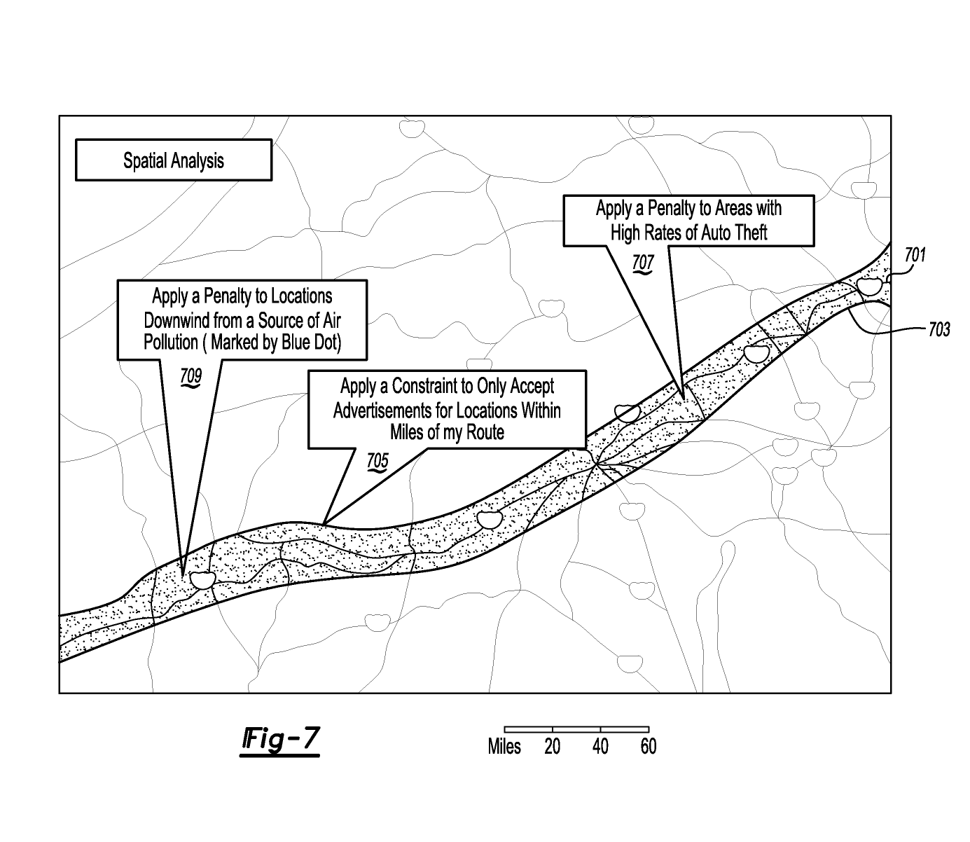

FIG. 7 shows an illustrative example of a route analysis result. In this example, a portion of a route 701 is shown. The route, in this example, includes a perimeter 703 that may vary by a time, distance from route, relevance, etc. Areas of higher density of business may provide a greater perimeter, as can be seen from the variances in perimeter size along the route. The perimeter can correspond, for example, to various advertisements/merchants proximal to the route 705.

Certain areas of the route may also be designated with markers that correspond to desirable/undesirable conditions. In the illustrative example shown, areas downwind from sources of pollution 709 and areas with high auto theft rates 707 are accordingly cordoned. Locations of businesses within these areas can be easily determined and have the appropriate weightings applied.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method comprising:
retrieving one or more data elements relating to user shopping habits;
identifying at least one area along the route as an area where a stop is likely;
identifying one or more merchants along a route corresponding to the one or more data elements, and within a proximity to the area(s) where a stop is likely;
identifying at least one advertisement for at least one of the one or more merchants; and
as a vehicle moves within a perimeter of a merchant for which an advertisement has been identified, presenting the advertisement to a vehicle occupant.

2. The method of claim 1, further comprising classifying a route to be traveled.

3. The method of claim 2, wherein the route is classified as a long distance route.

4. The method of claim 3, wherein the data elements relate to user shopping habits during long trips.

5. The method of claim 2, wherein the route is classified as a local route.

6. The method of claim 5, wherein the data elements relate to user shopping habits during local trips.

7. The method of claim 1, wherein the perimeter is based on at least one data element relating to user shopping habits.

8. The method of claim 1, wherein the proximity within which merchants are identified varies based on a projected reason for the likely stop.

9. The method of claim 8, wherein a plurality of areas are identified, at least two of the areas having stopping reasons associated therewith, different from each other.

10. The method of claim 9, wherein a stopping reason relates to refueling.

11. The method of claim 9, wherein a stopping reason relates to eating.

12. The method of claim 9, wherein a stopping reason relates to resting.

13. The method of claim 9, wherein a stopping reason relates to shopping.

14. The method of claim 9, wherein a perimeter associated with each area varies in size based on a stopping reason associated with the area.

15. A machine readable storage medium, storing instructions that, when executed by a processor, cause the processor to perform a method comprising:
retrieving one or more data elements relating to user shopping habits;
identifying one or more merchants along a route corresponding to the one or more data elements;
identifying at least one advertisement for at least one of the one or more merchants; and
as a vehicle moves within a perimeter of a merchant for which an advertisement has been identified, presenting the advertisement to a vehicle occupant.

16. The machine readable storage medium of claim 15, further comprising classifying a route to be traveled.

17. The machine readable storage medium of claim 15, wherein the perimeter is based on at least one data element relating to user shopping habits.

18. The machine readable storage medium of claim 15, further comprising:
identifying at least one area along the route as an area where a stop is likely, and wherein the identifying at least one merchant is limited to identifying merchants within the identified at least one area(s).

19. The machine readable storage medium of claim 18, wherein a plurality of areas are identified, at least two of the areas having stopping reasons associated therewith, different from each other.

20. A computer implemented method comprising:
tracking user progress along a route to determine one or more intermittent stopping location, where the user stops with the intention of making a purchase;
for each intermittent stopping location, recording data including at least time of day, distance from the route, and duration of time spent at the stopping location; and
aggregating recorded data to compile a user profile defining shopping habits of a user when detouring from a route.
